(19) United States
(12) Patent Application Publication
(10) Pub. No.: US 2014/0091942 A1
(43) Pub. Date: Apr. 3, 2014

(54) Hovering Spinning Display

(71) Applicant: Asian Express Holdings Limited, Houston, TX (US)

(72) Inventors: Darren Matloff, Mongkok (HK); Mak Man Wai, Kowloon Bay (HK)

(73) Assignee: Asian Express Holdings Limited, Houston, TX (US)

(21) Appl. No.: 14/035,867

(22) Filed: Sep. 24, 2013

Related U.S. Application Data
(60) Provisional application No. 61/705,564, filed on Sep. 25, 2012.

(51) Int. Cl. G06T 11/20

(52) U.S. Cl. CPC G06T 11/203
USPC 340/815.53

(57) ABSTRACT

A spinning display system includes a housing, a first blade assembly, a second blade assembly, at least one support arm extending radially outward from the housing, and a display panel coupled to the distal end of each support arm. The housing supports a motor and electronics, and the motor includes a motor shaft. The first blade assembly is coupled to the motor shaft. The second blade assembly is coupled to the housing. The motor is configured to spin the first blade assembly in a first direction about a longitudinal axis of the housing and spin the second blade assembly, the at least one support arm and the display panels in an opposite direction about the longitudinal axis of the housing. The display panel is configured to display a user-selected message while the display panel is spinning. Neither the first nor the second blade assembly is attached to the display panel.

### CROSS REFERENCE TO RELATED APPLICATIONS

The present application claims the benefit of priority from U.S. Provisional No. 61/705,564, filed Sep. 25, 2012, which is incorporated by reference in its entirety.

### FIELD OF THE DISCLOSURE

The present disclosure relates to the field of electronic visual displays. In some embodiments, the disclosure relates to displaying information with a spinning display panel.

### BACKGROUND

Flying and hovering devices, such as radio controlled toys, typically include various rotating components. For example, helicopters and “UFO”-type toys generally include a motor having a vertically-mounted shaft upon which a blade assembly is mounted. The spinning blade assembly generates enough lifting force to allow such devices to fly or hover in the air.

Such devices provide tremendous enjoyment to users; however such devices lack the ability to be customized or personalized in a manner particular to individual users. It would therefore be desirable to provide such a device that included visual display elements that could provide a readable message or graphic, even while the device is spinning and flying through the air.

### SUMMARY

Based on at least the foregoing, the present disclosure seeks to overcome some or all of the drawbacks discussed above and provide additional advantages over prior technologies. The present disclosure describes embodiments of wireless, spinning display systems. In many embodiments, such display systems are configured to fly or hover in the air, as well.

A spinning display system includes a housing, a blade assembly, and one or more display panels. The housing supports a motor and electronic components. The blade assembly and one or more display panels are coupled to the housing. The motor is configured to spin the blade assembly in a first direction about a longitudinal axis of the housing and spin the one or more display panels in an opposite direction about the longitudinal axis of the housing. The display panel is configured to display a user-selected message while the display panel is spinning.

A spinning display system includes a housing, a first blade assembly, a second blade assembly, at least one support arm extending radially outward from the housing, and a display panel coupled to the distal end of each support arm. The housing supports a motor and electronics, and the motor includes a motor shaft. The first blade assembly is coupled to the motor shaft. The second blade assembly is coupled to the housing. The motor is configured to spin the first blade assembly in a first direction about a longitudinal axis of the housing and spin the second blade assembly, the at least one support arm and the display panels in an opposite direction about the longitudinal axis of the housing. The display panel is configured to display a user-selected message while the display panel is spinning. Neither the first nor the second blade assembly is attached to the display panel.

A method of configuring a spinning display includes: retrieving an electronic message from an electronic memory; displaying the message on a spinning display, the spinning display comprising: a housing, the housing supporting a motor and electronic components, the motor comprising a motor shaft; a first blade assembly coupled to the motor shaft; a second blade assembly coupled to the housing; at least one support arm extending radially outward from the housing; and a display panel coupled to the distal end of each support arm; wherein the motor is configured to spin the first blade assembly in a first direction about a longitudinal axis of the housing and spin the second blade assembly, the at least one support arm, and the display panels in an opposite direction about the longitudinal axis of the housing; and wherein the display panel comprises a plurality of light emitting diodes linearly arranged along a vertical axis substantially parallel to the motor's shaft's longitudinal axis; wherein said displaying comprises activating and deactivating the light emitting diodes in predetermined sequences and for predetermined durations to cause a message to be displayed on the display panel while it is spinning; and wherein neither the first nor the second blade assembly is attached to the display panel.

For purposes of summarizing the disclosure, certain aspects, advantages and novel features of the disclosure have been described herein. It is to be understood that not necessarily all such aspects, advantages or features will be embodied in any particular embodiment of the disclosure.

In some embodiments, the spinning display system also includes a plurality of light emitting diodes linearly arranged. In some embodiments, the plurality of light emitting diodes includes five diodes. In some embodiments, the plurality of light emitting diodes are vertically aligned along an axis substantially parallel to the longitudinal axis of the housing. In some embodiments, the user-selected message is visible only while the display panel is spinning.

In some embodiments, the spinning display system also includes a remote controller configured to wirelessly communicate with the electronics. In some embodiments, the remote control is configured to control the blade assembly rotational speed. In some embodiments, the remote control is configured to generate a wireless command to change the message. In some embodiments, the remote control includes a display configured to display a new message prior to transmission to the electronics. In some embodiments, the electronics include a wireless radio frequency receiver.

In some embodiments, the display panel is supported at its upper and lower portions by upper and lower support arms, the upper support arms extending from the display panel to a hub, the lower support arms extending from the display panel to the housing. In some embodiments, the hub at least partially surrounds a shaft extension coupled to the motor, wherein the hub is free to rotate with respect to the shaft extension. In some embodiments, the blade assembly is positioned between the upper and lower support arms. In some embodiments, the spinning display system is configured to substantially hover when the blade assembly spins above a threshold rotational speed.

In yet another embodiment, a method of configuring a spinning display includes retrieving an electronic message from an electronic memory; and displaying the message on a spinning display, the spinning display including: a housing, the housing supporting a motor and electronic components; a blade assembly coupled to the housing; and one or more display panels coupled to the housing; wherein the motor has a shaft, the motor being configured to spin the blade assembly in a first direction about a longitudinal axis of the housing and spin the one or more display panels in an opposite direction about the longitudinal axis of the housing; and wherein the display panel comprises a plurality of light emitting diodes linearly arranged along a vertical axis substantially parallel to the motor's shaft's longitudinal axis; and wherein said displaying comprises activating and deactivating the light emitting diodes in predetermined sequences and for predetermined durations to cause a message to be displayed on the display panel while it is spinning.

In some embodiments, the displaying includes activating and deactivating the light emitting diodes based at least in part upon an angular rotational speed of the display panels. In some embodiments, the displaying comprises activating and deactivating the light emitting diodes independent of an angular rotational speed of the display panels. In some embodiments, the method also includes receiving a wireless command to change a value of a character in the message. In some embodiments, the method also includes displaying a different character in response to receiving the wireless command. In some embodiments, the predetermined durations are less than a time it takes one display panel to complete one rotation about the shaft longitudinal axis. In some embodiments, the predetermined durations are less than 25%, 5%, or 1% of the time it takes one display panel to complete one rotation about the shaft longitudinal axis.

### BRIEF DESCRIPTION OF THE DRAWINGS

The following drawings and the associated descriptions are provided to illustrate embodiments of the present disclosure and do not limit the scope of the claims.

FIG. 1 illustrates a perspective view of an embodiment of a spinning display system.

FIG. 2 illustrates a front view of the spinning display assembly of FIG. 1.

FIG. 3 illustrates a side view of the spinning display assembly of FIG. 1.

FIG. 4 illustrates a perspective view of the spinning display of FIG. 1 while it is spinning and displaying text information.

FIG. 5 illustrates a block diagram of the electronics housed within the spinning display of FIG. 1.

FIG. 6 illustrates a block diagram of the electronics of the controller of FIG. 1.

FIG. 7 illustrates a user interface of the controller of FIG. 1.

FIG. 8 illustrates one embodiment of a routine to configure the spinning display of FIG. 1.

FIG. 9 illustrates a perspective view of another embodiment of a spinning display assembly.

FIG. 10 illustrates a side view of the spinning display assembly of FIG. 9.

FIGS. 11 and 12 illustrate front and back views of a remote control compatible with the spinning display assembly of FIGS. 9 and 10.

FIG. 13 illustrates a block diagram of the remote control of FIGS. 11 and 12.

FIG. 14 illustrates one embodiment of the user interface of the remote control of FIGS. 11-13.

### DETAILED DESCRIPTION

The present disclosure generally relates to electronic display technology, for example, displays that spin about an axis and illuminate one or more light elements in order to create an image and/or text. In some embodiments, the display is incorporated into a flying device, such as a toy helicopter or hovering craft. The flying display allows the user to customize his toy, or to display a predetermined message customizable by the user.

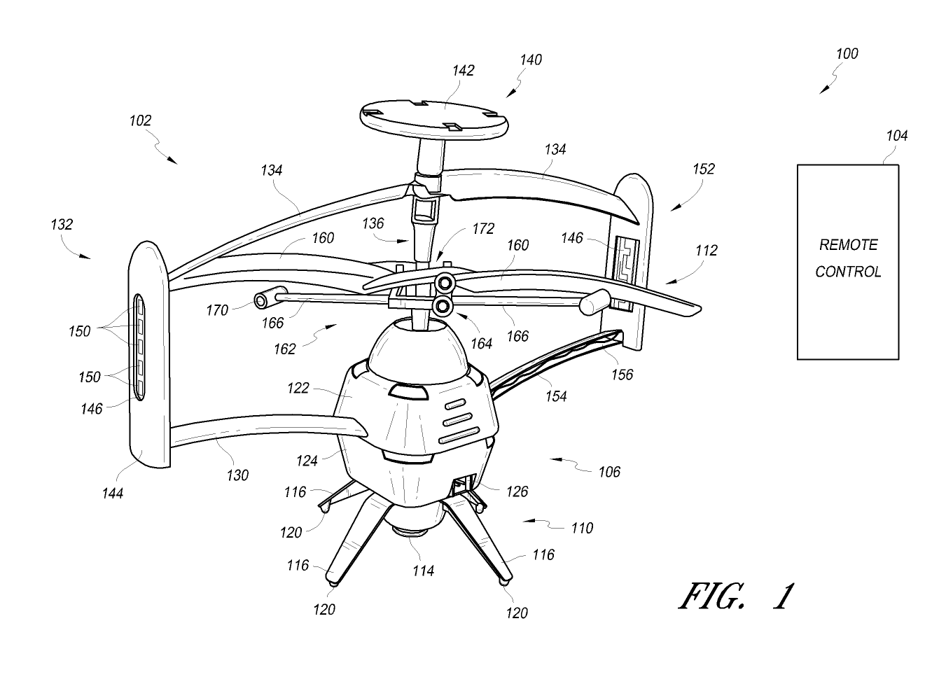

FIG. 1 illustrates one embodiment of a spinning display system 100. The system 100 includes a spinning display assembly 102 and a wireless controller 104. The spinning display assembly 102 is shown in the form of a remotely-controllable hovering device, such as a flying toy. In other embodiments, the spinning display assembly 102 has one or more other forms (e.g., a fan, a UFO, a car, a wheel, a gear, a propeller, a helicopter, an airplane, a hat, a clock, a table-top unit, etc.).

The spinning display assembly 102 includes a housing 106, a base 110, and a blade assembly 112. The base 110 is coupled to the housing 106 via a pin 114. The pin 114 extends through an opening in the base 110 to the housing 106. The base 110 is configured to rotate about the pin 114 with respect to the housing 106. By rotationally decoupling the base 110 from the housing 106, the housing 106 is able to take off (e.g., lift) and land (e.g., descend) without falling over, as described in greater detail below. The base 110 includes several legs 116 and a foot 120 positioned near the distal end of each leg 116.

The housing 106 includes an upper portion 122 and a lower portion 124. The housing 106 encloses various electronic components, such as those described below with respect to FIG. 5. An opening 126 in the housing 106 provides access to a power port that is used to charge a power storage device enclosed within the housing 106.

Right and left lower support arms 130 extend substantially horizontally from the housing 106. Each lower support arm 130 supports a display panel 132. Upper support arms 134 extend from the display panels 132 to a hub 136 that is coaxially aligned with the longitudinal axis of the housing 106. A cap 140 rests above the hub 136. An upper surface 142 of the cap 140 has a substantially larger surface area than the cross-sectional area of the hub 136. The cap 140 provides a protective shield to the spinning display assembly 102. For example, the cap 140 will protect the spinning display assembly 102 during use, for example, if accidentally flown or elevated into a ceiling or other obstruction.

Each display panel 132 is formed from a vertical support 144 attached to the distal ends of each lower and upper support arm 132, 134. Each display panel 132 houses a printed circuit board (PCB) 146 that supports one or more light emitting diodes (LEDs) 150. In the illustrated embodiment, the PCT 146 supports five LEDs 150. The LEDs 150 are oriented vertically, substantially parallel to the spinning display assembly's 102 longitudinal axis. The LEDs 150 are visible through an opening 152 in the vertical support 144. The LEDs 150 include LEDs of one or more color. For example, in some embodiments, the LEDs 150 include red, blue, white, yellow, amber, purple, green, etc., LEDs. In some embodiments, the LEDs 150 on the left display panel 132 are different colors than the LEDs 150 on the right display panel 132.

The electronics (not shown) within the housing 106 control the activation and deactivation of the LEDs 150. In some embodiments, the electronics pulse the LEDs 150 on and off to create visual images and/or text as the display panel 132 spins about the assembly's 102 longitudinal axis. Wires 154 extend from the electronics to the PCBs 146. Control signals from the electronics are sent to the PCBs 146 via the wires 154. The wires 154 are supported within channels 156 formed in each of the lower support arms 130.

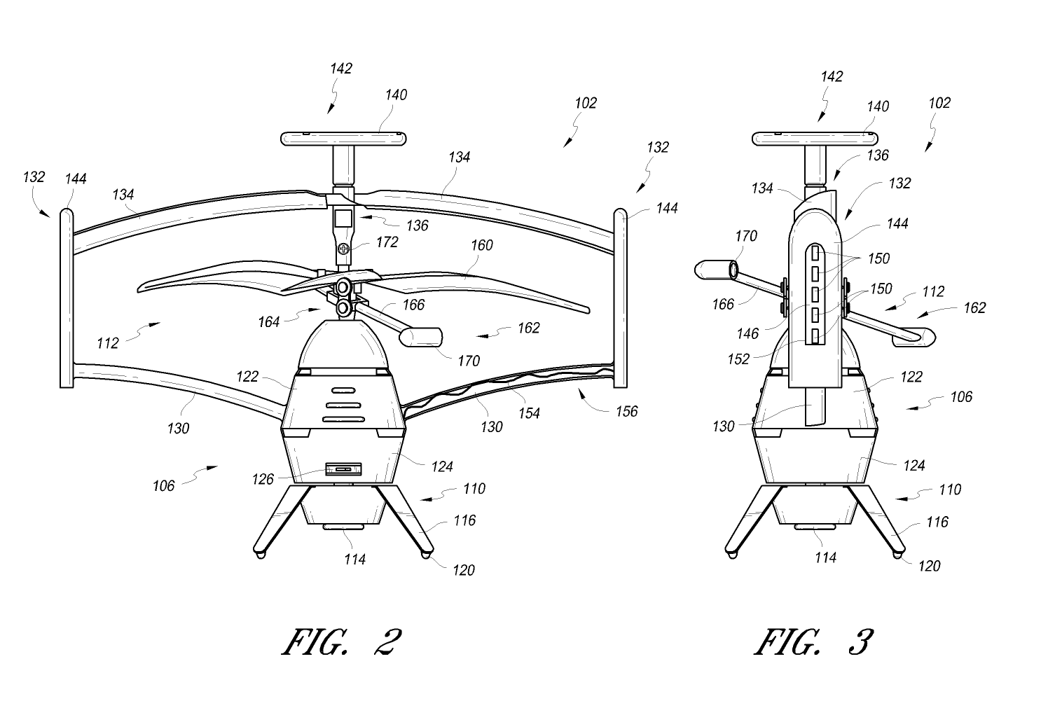

The blade assembly 112 includes blades 160 and a flybar assembly 162. The blades 160 are coupled to the flybar assembly 162 via linkage 164. The flybar assembly 162 includes flybar rods 166 that extend from the linkage 164. Counter balances 170 are attached to the distal ends of the flybar rods 160. The counter balances 170 help stabilize the spinning display assembly 102 during flight. The blade assembly 112 is secured to a shaft (not shown) via a shaft coupling 172. In one embodiment, the shaft coupling 172 includes a screw, such as shown in FIG. 2.

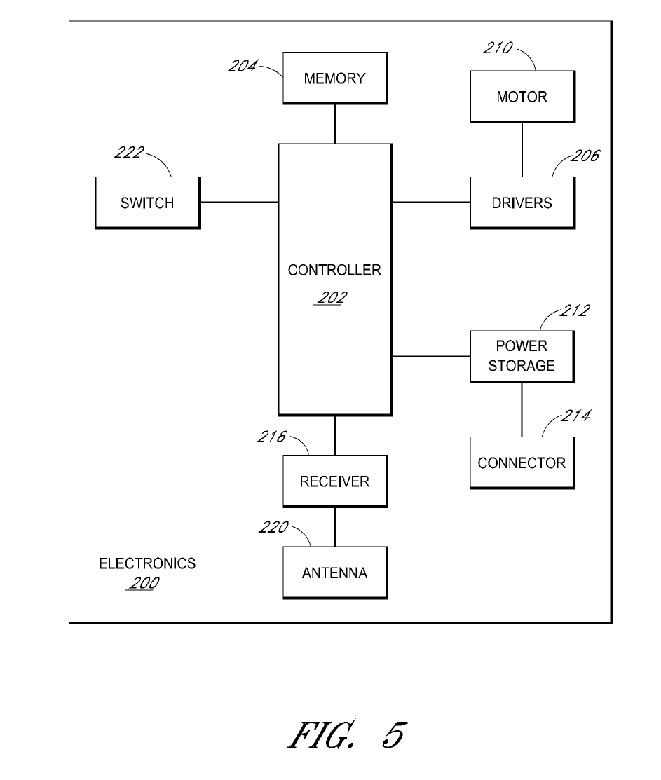

A motor (discussed below) positioned within the housing 106 causes the shaft to spin. The spinning shaft rotates the blade assembly 112 with respect to the motor and housing 106. The blade assembly 112 generates a lifting force as it spins, which causes the spinning display assembly 102 to lift, hover and/or fly, as shown in FIG. 4. In some embodiments, the motor is directly coupled to the shaft. For example, a shaft extending from the motor is attached to the blade assembly 112. In other embodiments, the motor is indirectly coupled to the shaft. For example, a motor shaft extending from the motor is coupled to the shaft via one or more gears (not shown).

The motor is fixed to the housing 106. Therefore, as the motor spins the shaft in one direction, the motor itself spins with respect to the shaft in the opposite direction. For example, when the motor is activated, the blade assembly 112, flybar assembly 162 (sometimes referred to as a stabilizer bar assembly 162), and linkage 164 spin clockwise (as observed from above) and the housing 106, lower support arms 130, display panel 132 and upper support arms 134 spin in a counterclockwise direction (as observed from above). The upper support arm 134 is shaped like the rotor blade 160, and provides lift to the display assembly 102 as it rotates. The upper support arm 134 and its blade shape are attached to and/or integrally formed with each spinning display panel 132. The spinning display panel 132 causes the LEDs 150 to spin in a counterclockwise direction, as well. A processor (or microcontroller or other control circuit, not shown), within the housing 106 causes activation and deactivation of the LEDs in a sequence that causes a user-configurable text message or other graphic to be displayed around the perimeter of the circle defined by the spinning display panel 132, as illustrated in FIG. 4.

In the illustrated embodiment, the word “TEXT” appears. The word is formed by activating the LEDs in a sequence and duration that depends upon the text character or graphic image that is to be displayed. For example, in the illustrated embodiment, the top-most LED is LED1, the bottom-most LED is LED5, and the three LEDs in between are LED2, LED3, and LED4, respectively. To create the letter “T”, the five LEDs 150 (LED1-LED5) are activated and deactivated in the following sequence over the time periods T1-T5:

TABLE 1
LED activation and deactivation sequence to display the letter “T”

| LED | T1 | T2 | T3 | T4 | T5 |
|---|---|---|---|---|---|
| LED1 | On | On | On | On | On |
| LED2 | Off | Off | On | Off | Off |
| LED3 | Off | Off | On | Off | Off |
| LED4 | Off | Off | On | Off | Off |
| LED5 | Off | Off | On | Off | Off |

A space is created after the character “T” by deactivating all the LEDs 150 during the next time period (e.g., T6). The remaining characters are created by activating and deactivating the LEDs 150 in a similar manner.

The duration of each time period T1-T5 may be fixed, or may vary depending upon the rotational speed or an indication of the rotational speed of the display panel 132. For example, as the display panel 132 rotates at higher rotational velocities, the duration of each time period may be reduced. Similarly, as the display panel 132 rotates at lower rotational velocities, the duration of each time period may be increased. In some embodiments, the time period duration is selected to cause the characters produced by the display panel 132 to appear to be stationary or substantially stationary as the spinning display assembly 102 hovers. In other embodiments, the time period duration is predetermined and fixed. In some embodiments all of the time periods have the same duration, and in others, at least some of the time periods differ from each other.

One embodiment of the electronics 200 supported by the housing 106 of the spinning display system 102 are illustrated in the block diagram of FIG. 5. The electronics 200 include a controller 202, a memory 204, drivers 206, a motor 210, power storage 212, a connector 214, a receiver 216, an antenna 220, and a power switch 222. The controller 202 can include a microcontroller, a microprocessor, logic and/or other circuits for coordinating the communication and operation of the various electronic 200 components.

The memory 204 can include a RAM, ROM, EPROM, EEPROM, etc. The memory 204 stores a program that determines each time period and activation sequences of the LEDs 150. The drivers 206 receive control commands from the controller 202 and in response activate one or more of the LEDs 150. The drivers 206 can also be configured to control the operation of the motor 210. For example, the controller 202 can cause a driver 206 to deliver more or less energy from the power storage 212 to the motor 210 to increase or decrease the rotational velocity of the blade assembly 112 and display panels 132.

The motor 210 can include a direct drive motor, a gear coupled motor, a belt coupled motor, etc. The motor 210 causes the blade assembly 112 and display panels 132 to spin in opposite directions with respect to each other, as discussed above. In one embodiment, the motor includes a DC motor. The power storage unit 212 can include a battery, capacitor, etc. In one embodiment, the power storage unit 212 includes a rechargeable battery. The power storage unit 212 stores the electrical energy used to power the microcontroller, activate the LEDs 150, and activate the motor 210.

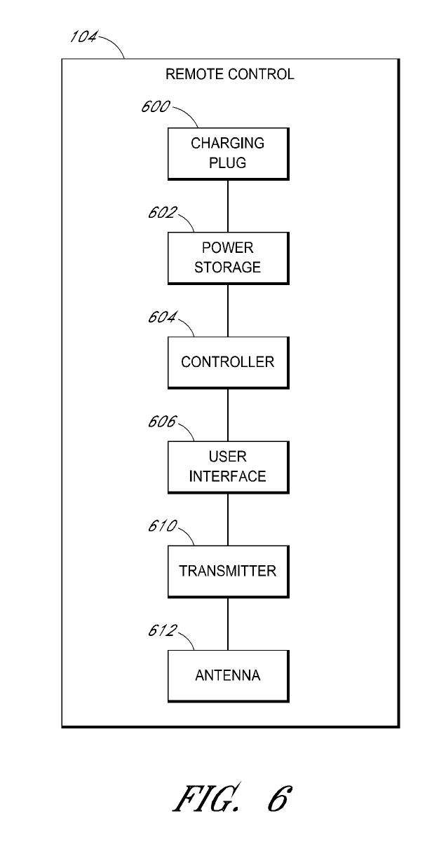

The connector 214 provides a power port through with the power storage unit 212 may be recharged. In one embodiment, the connector 214 is accessible via the opening 126 of the housing 106, as illustrated in FIG. 1. The receiver 216 is configured to enable wireless communication between the spinning display assembly 102 controller 202 and a remote control 104. One embodiment of the remote control 104 is illustrated in FIG. 6. The receiver 216 can include any type of wireless communication receiver, including a radio frequency receiver, infrared receiver, Bluetooth receiver, etc. The receiver 216 receives the control signals from the remote control 106 via an antenna 220. In some embodiments, the antenna 220 is an LED or other device suitable for receiving a wireless control signal from a remote control 106. A switch 222 activates and deactivates the electronics 200, thereby turning the spinning display assembly 102 on or off.

FIG. 6 illustrates one embodiment of a remote control unit 104. The remote control unit 104 includes a charging plug 600, a power storage unit 602, a controller 604, a user interface 606, a transmitter 610, and an antenna 614. The remote control unit 104 is configured to send wireless control signals to the spinning display assembly 102. The wireless control signals can control the speed at which the blade assembly 112 spins to control the height at which the spinning display assembly hovers in the air.

The charging plug 600 is configured to mate with the connector 214 of the electronics 200 and to provide charging energy to the power storage unit 212 located within the spinning display assembly. The charging plug 600 is in communication with a power storage unit 602. The power storage unit 602 can include one or more batteries. In one embodiment, the power storage unit 602 stores about 9 V DC. In other embodiments, the power storage unit 602 stores about 6, 12, or 15 V DC. The power storage unit 602 can include one or more standard sized batteries. For example, in one embodiment, the power storage unit 602 includes 6 AA batteries. In other embodiments, the power storage unit 602 may include AAA, C and/or D sized batteries.

The controller 604 receives input commands from the user via the user interface 606 and converts those commands into signals for transmission to the spinning display assembly 102. The controller 604 can include any of a variety of controllers, processors, microcontrollers, microprocessors, logic, etc. In some embodiments, the controller 604 also includes drivers to drive one or more LEDs positioned on the user interface 606. In some embodiments, the controller 604 includes drivers to drive the transmitter 616.

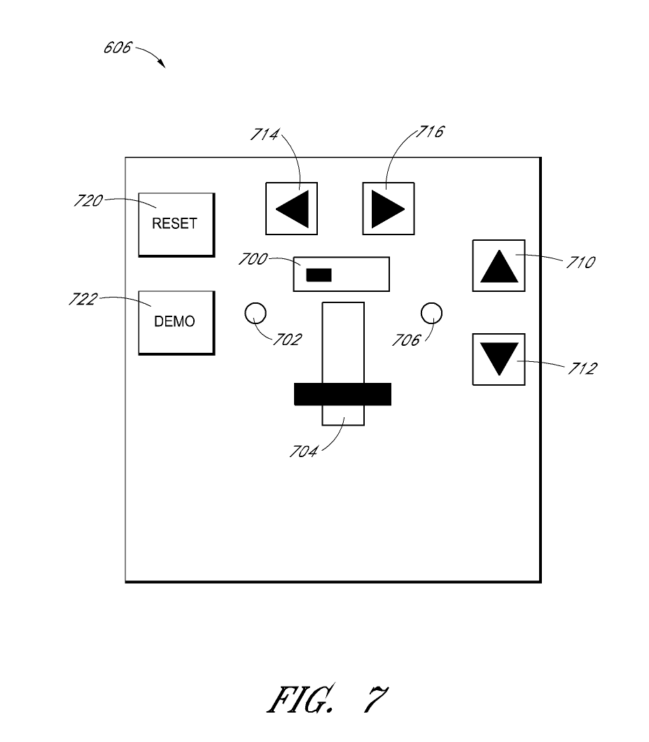

The user interface 606 provides a mechanism for a user to program the text characters and graphics to be displayed on the spinning display panel 132 of the spinning display assembly 102. One embodiment of a user interface 606 is illustrated in FIG. 7, discussed below.

A transmitter 616 converts electrical control signals received from the controller 604 into wireless control signals for transmission to the electronics 200 of the spinning display assembly 102. For example, in one embodiment, the user issues a command via the remote control 104 to increase the power to the motor, and thus cause the spinning display assembly 102 to spin faster. The user's command is received via the user interface 606 and communicated to the controller 604. The controller 604 determines sends the command to the transmitter 610, which converts the command to a wireless signal. The wireless signal is transmitted from the transmitter 610 via an antenna 614. The wireless signal is received by the antenna 220 of the electronics 200, where it is further processed by the controller 202. In response to the received signal, the controller 202 activates the driver 206 to cause the motor 210 to spin faster.

FIG. 7 illustrates one embodiment of a user interface 606. The user interface 606 includes a power switch 700, a power indicator 702, speed controller 704, a charging indicator 706, up and down arrow buttons 710, 712, left and right arrow buttons 714, 716, a reset button 720, and a demo button 722. The power switch 700 turns on and off the power to the remote control unit 104. When the power is on, the power indicator 702 illuminates. In one embodiment, the power indicator 702 includes a LED.

The speed controller 704 can include any of a variety of variable adjustment mechanisms, such as a potentiometer, a slider, dial, etc. The position of the speed controller 704 controls the amount of power delivered to the motor 210 of the spinning display assembly 102. For example, in the illustrated embodiment, at the lowest, minimal position, no power is delivered to the motor 210. As the slider of the speed controller 704 is raised, more and more power is gradually transferred to the motor 210, and the blade assembly 112 of the spinning display assembly 102 begins to spin. After a certain speed is achieved, the spinning display assembly 102 will lift off and fly in the air, displaying its programmed message, as discussed above.

A charging indicator 706 indicates when the charging plug 600 of the remote controller 104 is coupled to the spinning display assembly connector 214. The charging indicator 706 further indicates when power is being transferred from the remote controller's power storage unit 602 to the spinning display assembly's power storage unit 212.

Arrow buttons 710, 712, 714, 716 allow the user to adjust the text or graphical message displayed on the spinning display assembly 102 one character at a time. The user uses the up and down arrows 710, 712 to cycle through a predetermined catalog of available characters (e.g., the letters A-Z, numbers 0-9, and other letters or characters of any desired language, such as Chinese, Japanese, Korean, Russian, etc.) The left and right arrows 714, 716 allow the user to move from one character to the next in the display message. For example, if the user wanted to display the message “SKYWRITER,” he would first press the up or down arrows 710, 712 until the letter S appeared as the first character in the message. The user would then press the right arrow 714 to move to the next character. The user would then press the up or down arrows 710, 712 until the letter K appeared as the second character in the message. The user would continue this procedure until the complete message has been programmed into the spinning display assembly 102.

A reset button 720 allows the user to reset the display message to a factory or user-programmed default message. For example, in one embodiment, pressing the reset button 720 clears or deletes the message programmed by the user from memory. Pressing a demo button 722 cycles the display message through multiple words or images stored in the spinning display assembly's memory. For example, when spinning, the spinning display assembly may display the word, “SKYWRITER”. Pressing the demo button 722 can cause the word “SKYWRITER” to be replaced with the word, “IS”. Pressing the demo button 722 another time can cause the word “IS” to be replaced with the word “AWESOME!”. Any of a variety of word sequences may be programmed into the device to allow the device to display multiple words and sentences.

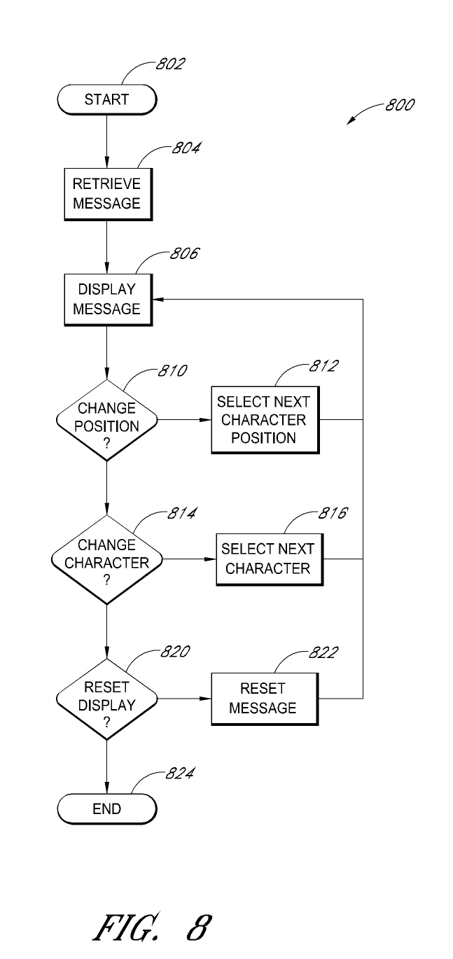

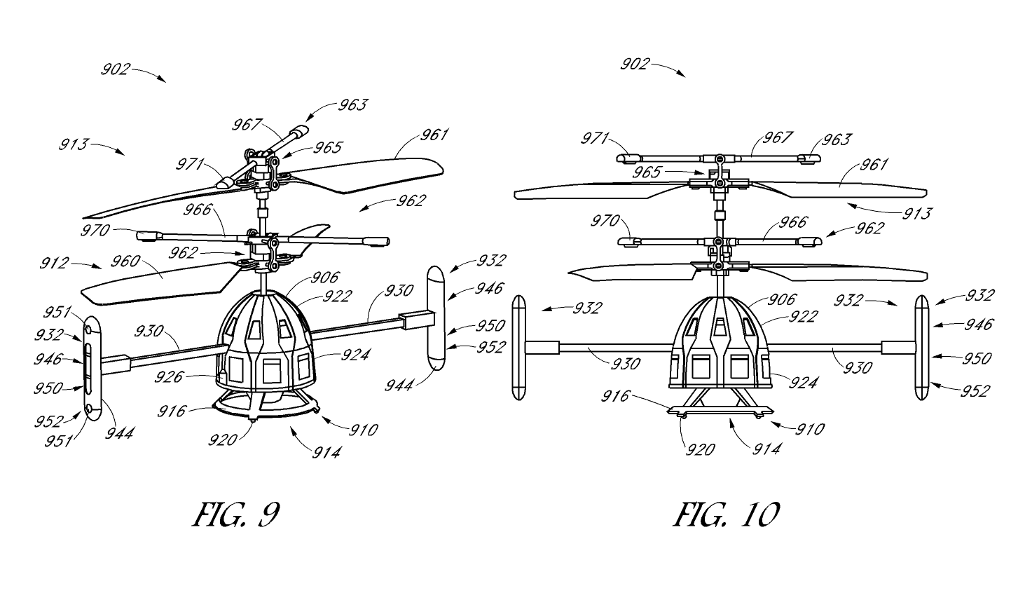

FIG. 8 illustrates one embodiment of a method of configuring a spinning display. The method 800 may be performed by the remote controller 104, described above. The method 800 begins at block 802. At block 804, the method 800 retrieves a message that has been stored in a memory. At block 806, the method 800 displays the message. The message may be displayed on a display unit located in a remote control unit, or on the spinning display panel 132 of a spinning display assembly. At block 810, the method 800 determines whether a command to change character position within the message has been received. If a command to change character position within the message has been received (for example, if a right or left arrow 714, 716 has been pressed), the method 800 proceeds to block 812. At block 812, the method 800 selects the next character in the message. For example, if a right arrow button has been pressed, the method 800 selects the next character to the right of the present character. If at block 810 a change position command has not been received, the method 800 proceeds to block 814.

At block 814, the method 800 determines whether a command to change a character value has been received. If a command to change a character value has been received (for example, if an up or down arrow has been pressed), the method 800 proceeds to block 816. At block 816, the method displays the next character in the sequence at current character position. For example, if the character displayed at the current position within the message is the letter “S” and the up arrow 710 is pressed, the method 800 will change the displayed character from an “S” to a “T”. If at block 814 a change character command has not been received, the method 800 proceeds to block 820.

At block 820, the method 800 determines whether a command to reset the display has been received. If a command to reset the display has been received (for example, if a reset button 720 is pressed), the method 800 proceeds to block 822. At block 822, the method 800 erases the message programmed by the user, and displays a default, pre-programmed message on the display panel 132 of the spinning display assembly 102. If at block 820 a reset display command has not been received, the method 800 proceeds to block 824. The method 800 ends at block 824.

FIG. 9 illustrates another embodiment of a spinning display assembly 902, which is similar to the spinning display assembly 102 discussed above. The spinning display assembly 902 is shown in the form of a remotely-controllable hovering device, such as a flying toy. In other embodiments, the spinning display assembly 102 has one or more other forms (e.g., a fan, a UFO, a car, a wheel, a gear, a propeller, a helicopter, an airplane, a hat, a clock, a table-top unit, etc.).

The spinning display assembly 902 includes a housing 906, a base (or landing gear) 910, a lower blade assembly 912, and an upper blade assembly 913. The base 910 is coupled to the housing 906 via a pin 914. The pin 914 extends through an opening in the base 910 to the housing 906. The base 910 is configured to rotate about the pin 914 with respect to the housing 906. By rotationally decoupling the base 910 from the housing 906, the housing 906 is able to take off (e.g., lift) and land (e.g., descend) without falling over, as described in greater detail below. The base 910 is in the form of a ring 916 having several feet 920 positioned around its perimeter. The ring-shaped base 910 provides additional stability during take-off and landing, and allows the spinning display assembly 902 to be easily landed without falling over.

The housing 906 can be formed of a single portion, or may include an upper portion 922 and a lower portion 924, as shown in the illustrated embodiment. The housing 906 encloses various electronic components, such as those described above with respect to FIG. 5. An opening 926 in the housing 906 provides access to a power port that is used to charge a power storage device enclosed within the housing 906.

Right and left support arms 930 extend substantially horizontally from the housing 906. Each lower support arm 930 supports a display panel 932. The spinning rotating display assembly 902 does not include upper support arms or a cap, as shown in the embodiment of FIG. 1. Instead, the display assembly includes dual rotor blade assemblies, both of which are neither integrated with nor attached to the display panels 932. For example, unlike the embodiment of FIG. 1, the display assembly 902 is supported by only a single pair of right and left support arms 930.

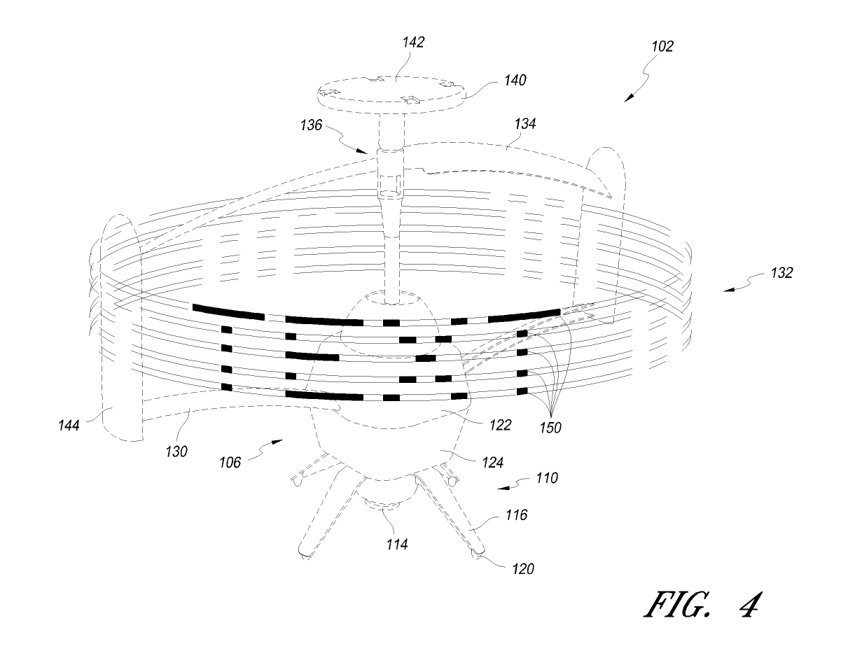

Each display panel 932 is formed from a vertical support 944 attached to the distal ends of each support arm 930. Each display panel 932 houses a printed circuit board (PCB) 946 that supports one or more light emitting diodes (LEDs) 950. In the illustrated embodiment, the PCB 946 supports five LEDs 950. The LEDs 950 are oriented vertically, substantially parallel to the spinning display assembly's 902 longitudinal axis. The LEDs 950 are visible through an opening 952 in the vertical support 944. The LEDs 950 include LEDs of one or more color. For example, in some embodiments, the LEDs 950 include red, blue, white, yellow, amber, purple, green, etc., LEDs. In some embodiments, the LEDs 950 on the left display panel 932 are different colors than the LEDs 950 on the right display panel 932. In some embodiments, LEDs and a PCB are provided on only one display panel 932. In some embodiments, the display panel 932 includes additional LEDs 951 to create additional visual effects. For example, in some embodiments, the additional LEDs 951 have different colors than each other and/or the LEDs 950. In one embodiment, the LEDs 950 are used to create text messages that are customizable by the user, according to any of the methods described herein, including those described in connection with the embodiments of FIGS. 1-8. In some embodiments, the additional LEDs 951 are used to create a solid or flashing ring of color during use.

The electronics (not shown) within the housing 906 control the activation and deactivation of the LEDs 950. In some embodiments, the electronics pulse the LEDs 950 (and sometimes the additional LEDs 951, as well) on and off to create visual images and/or text as the display panel 932 spins about the assembly's 902 longitudinal axis. Wires (not shown) extend from the electronics to the PCBs 946. Control signals from the electronics are sent to the PCBs 946 via the wires. The wires are supported within channels formed in each of the support arms 930.

The upper and lower blade assemblies 912, 913 includes blades 960, 961 and flybar assemblies 962, 963 (sometimes referred to as stabilizer bar assemblies 962, 963). The blades 960, 961 are coupled to the respective flybar assemblies 962, 963 via linkage 964, 965. The flybar assemblies 962, 963 include stabilizer rods 966, 967 that extend from each linkage 964, 965. Counter balances 970, 971 are attached to the distal ends of the stabilizer rods 960. The counter balances 970, 971 help stabilize the spinning display assembly 902 during flight. The blade assemblies 912, 913 is secured to a shaft via a shaft coupling. In one embodiment, the shaft coupling includes a screw.

A motor positioned within the housing 906 causes the shaft to spin in one direction, and the housing 906 to spin in an opposite direction. In one embodiment, the upper blade assembly 913 is coupled to the shaft, and the lower blade assembly 912 is coupled to the housing 906, and therefore spin in opposite directions with respect to each other. In another embodiment, the upper blade assembly 913 is coupled to the housing 906 and the lower blade assembly 912 is coupled to the shaft. The spinning shaft rotates one of the blade assemblies with respect to the other blade assembly, the motor and housing 906. The blade assemblies 912, 913 generate a lifting force as they spin, which causes the spinning display assembly 902 to lift, hover and/or fly. In some embodiments, the motor is directly coupled to the shaft. For example, a shaft extending from the motor is attached to the blade assembly. In other embodiments, the motor is indirectly coupled to the shaft. For example, a motor shaft extending from the motor is coupled to the shaft via one or more gears (not shown).

The motor is fixed to the housing 906. Therefore, as the motor spins the shaft in one direction, the motor itself spins with respect to the shaft in the opposite direction. For example, in one embodiment, when the motor is activated, the lower blade assembly 912, lower stabilizer assembly 962, and linkage 964 spin clockwise (as observed from above) and the housing 906, lower support arms 930, display panel 932 and upper blade assembly 913 spin in a counterclockwise direction (as observed from above). A processor (or microcontroller or other control circuit, not shown), within the housing 906 causes activation and deactivation of the LEDs in a sequence that causes a user-configurable text message or other graphic to be displayed around the perimeter of the circle defined by the spinning display panel 932, in a similar manner as the spinning display panel 132 illustrated in FIG. 4.

In some embodiments, one or more gear assemblies are provided to enable one or both of the blade assemblies 912, 913 to spin at a different speed than the housing 906 and/or lower support arm 930. Such configuration can provide improved flying and hovering control, and stability, and a more easily readable message provided via the display panel 932. Messages are displayed on the spinning display assembly 902 using any of the methods discussed above with respect to FIGS. 1-8.

In another embodiment (not shown), one of the blade assemblies is integrated into the housing itself. For example, an the body of the housing 906 can be shaped with curvature in its wall to form an airfoil. The spinning housing will generate lift to help lift the display assembly 902 off the ground and hover in the air. In some embodiments, the housing 906 has at least a partially helical airfoil wall shape. In some embodiments, the housing 906 includes an airfoil attached to or integrated directly into the housing 906 outer wall.

One embodiment of the electronics 200 supported by the housing 906 of the spinning display system 902 is illustrated in the block diagram of FIG. 5. The electronics 200 include a controller 202, a memory 204, drivers 206, a motor 210, power storage 212, a connector 214, a receiver 216, an antenna 220, and a power switch 222, as discussed above with respect to FIG. 5.

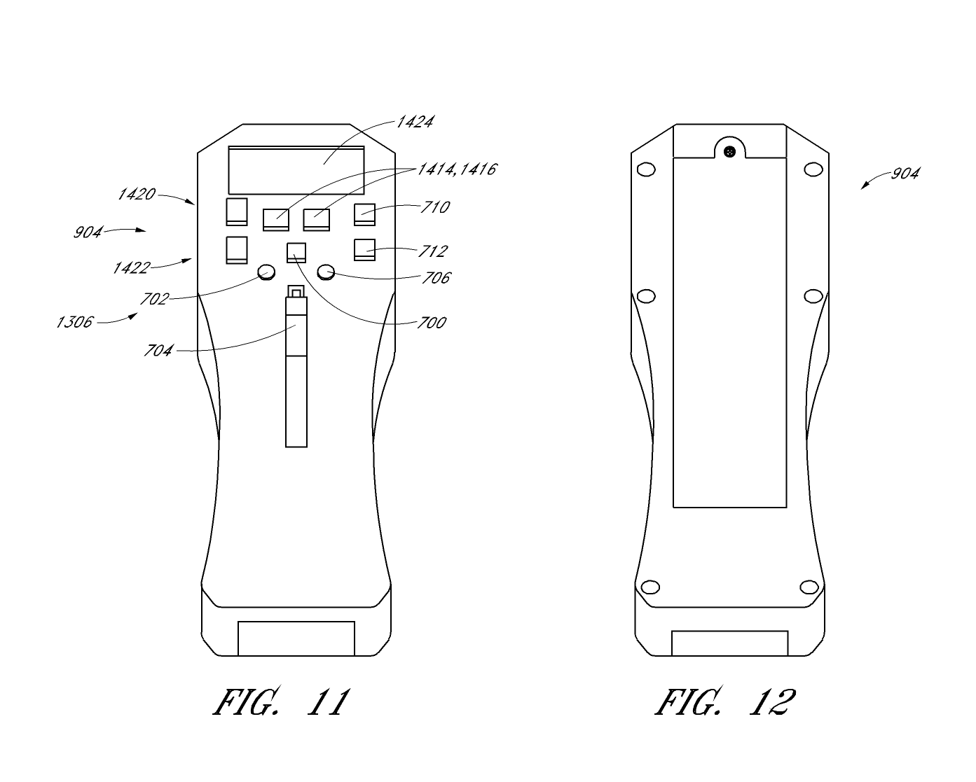

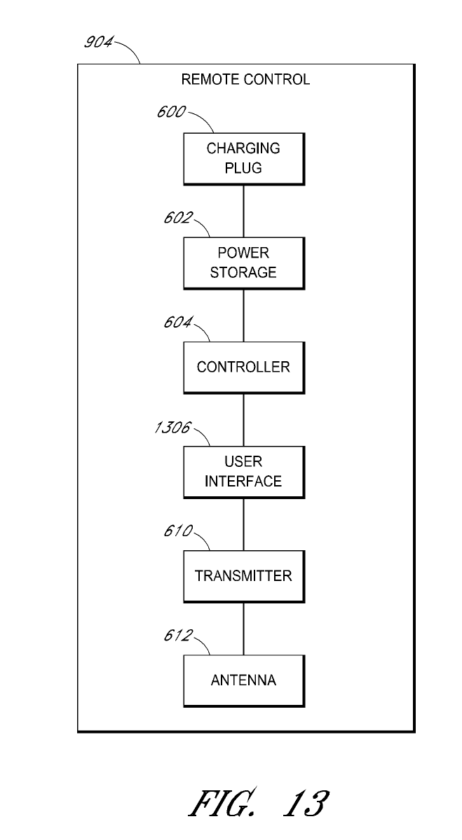

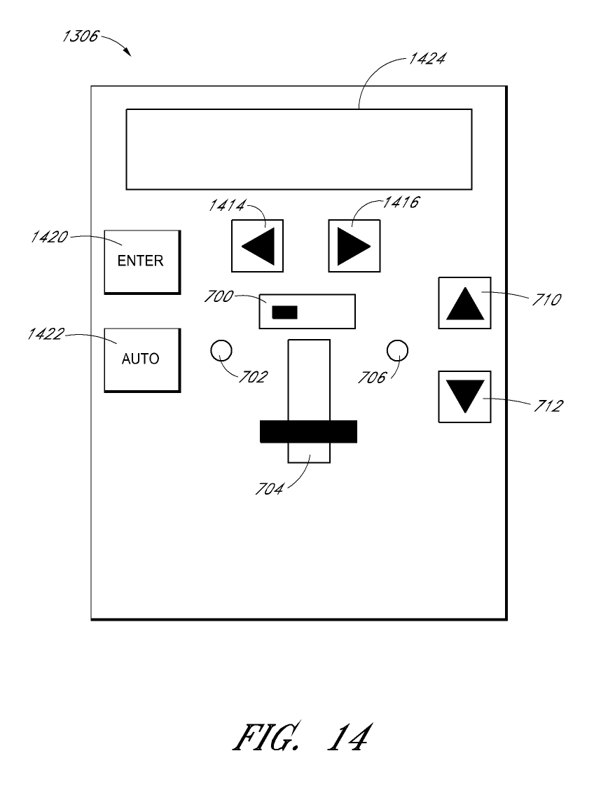

FIGS. 11-13 illustrate one embodiment of a remote control unit 904 that can be used to control and program the display of the display assembly 902. The remote control unit 904 is similar to the remote control unit 104, discussed above. The remote control unit 904 includes a charging plug 600, a power storage unit 602, a controller 604, a transmitter 610, and an antenna 614, as discussed above with respect to FIG. 6. The remote control unit 904 also includes a user interface 1306, as shown in FIG. 14. The remote control unit 904 is configured to send wireless control signals to the spinning display assembly 902. The wireless control signals can control the speed at which the blade assemblies 912, 913 spin to control the height at which the spinning display assembly hovers in the air.

The user interface 1306 provides a mechanism for a user to program the text characters and graphics to be displayed on the spinning display panel 932 of the spinning display assembly 902. One embodiment of a user interface 1306 is illustrated in FIG. 14.

FIG. 14 illustrates one embodiment of a user interface 1306. The user interface 1306 includes a power switch 700, a power indicator 702, speed controller 704, a charging indicator 706, and up and down arrow buttons 710, 712, as discussed above with respect to FIG. 7. The user interface 1306 includes left and right trim adjust buttons 1414, 1416, an “enter” button 1420, and an “auto” button 1422.

Arrow buttons 710, 712, and in some embodiment, 1414, 1416 allow the user to adjust the text or graphical message displayed on the spinning display assembly 902 one character at a time. The user uses the up and down arrows 710, 712 to cycle through a predetermined catalog of available characters (e.g., the letters A-Z, numbers 0-9, and other letters or characters of any desired language, such as Chinese, Japanese, Korean, Russian, etc.) The left and right arrows 1414, 1416 (or in some embodiments, the “enter” button 1420) allow the user to move from one character to the next in the display message. For example, if the user wanted to display the message “SKYWRITER,” he would first press the up or down arrows 710, 712 until the letter S appeared as the first character in the message. The user would then press the right arrow 1414 to move to the next character. The user would then press the up or down arrows 710, 712 until the letter K appeared as the second character in the message. The user would continue this procedure until the complete message has been programmed into the spinning display assembly 902. The remote control 904 also includes a display 1424 to allow the user to visualize the message to be displayed on the spinning display assembly 902.

In some embodiments, the “enter” or “auto” button 1420, 1422 provides the same functionality as the reset button 720 discussed above, e.g., to allow the user to reset the display message to a factory or user-programmed default message. For example, in one embodiment, pressing a button 1420, 1422, clears or deletes the message programmed by the user from memory. Pressing the other button 1422, 1420 cycles the display message through multiple words or images stored in the spinning display assembly's memory. For example, when spinning, the spinning display assembly may display the word, “SKYWRITER”. In one embodiment, pressing the “auto” button 1422 can cause the word “SKYWRITER” to be replaced with the word, “IS”. Pressing the “auto” button 1422 another time can cause the word “IS” to be replaced with the word “AWESOME!”. Any of a variety of word sequences may be programmed into the device to allow the device to display multiple words and sentences.

The right and left arrows 1414, 1416 can also be used to control the trim of the hovering display assembly 902 during flight. Trim adjustment provides additional stability and improved flight performance.

All publications, patents, and patent applications mentioned in this specification are herein incorporated by reference to the same extent as if each individual publication, patent, or patent application was specifically and individually indicated to be incorporated by reference.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The steps of a method, process, routine, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An example storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase at least one of X, Y and Z,” unless specifically stated otherwise, is to be understood with the context as used in general to convey that an item, term, etc. may be either X, Y, or Z, or a combination thereof. Thus, such conjunctive language is not generally intended to imply that certain embodiments require at least one of X, at least one of Y and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

1. A spinning display system, comprising:
a housing, the housing supporting a motor and electronic components, the motor comprising a motor shaft;
a first blade assembly coupled to the motor shaft;
a second blade assembly coupled to the housing;
at least one support arm extending from the housing; and
a display panel coupled to the distal end of each support arm;
wherein the motor is configured to: (1) spin the first blade assembly in a first direction about a longitudinal axis of the housing, and (2) spin the second blade assembly, the at least one support arm, and the display panels in an opposite direction about the longitudinal axis of the housing, and
wherein the display panel is configured to display a user-selected message while the display panel is spinning.

2. The spinning display system of claim 1, wherein the display panel includes a plurality of light emitting diodes linearly arranged.

3. (canceled)

4. The spinning display system of claim 2, wherein the plurality of light emitting diodes are vertically aligned along an axis substantially parallel to the longitudinal axis of the housing.

5. The spinning display system of claim 1, wherein the user-selected message is visible only while the display panel is spinning.

6. The spinning display system of claim 1, further comprising a remote controller configured to wirelessly communicate with the electronics.

7. The spinning display system of claim 6, wherein the remote control is configured to: (1) control the blade assembly rotational speed, (2) generate a wireless command to change the message, or (3) both.

8. (canceled)

9. The spinning display system of claim 6, wherein the remote control comprises a display configured to display a new message prior to transmission to the electronics.

10. The spinning display system of claim 1, wherein the electronics comprise a wireless radio frequency receiver.

11. The spinning display system of claim 1, wherein each display panel is supported near its center region by a single support arm.

12. The spinning display system of claim 1, wherein second blade assembly at least partially surrounds a shaft extension coupled to the motor, wherein the second blade assembly is free to rotate with respect to the shaft extension.

13. The spinning display system of claim 12, wherein the second blade assembly is positioned between the first blade assembly and the housing.

14. The spinning display system of claim 1, wherein the spinning display system is configured to substantially hover when the first and second blade assemblies spins above a threshold rotational speed.

15. A method of configuring a spinning display, comprising:
retrieving an electronic message from an electronic memory;
displaying the message on a spinning display, the spinning display comprising:
a housing, the housing supporting a motor and electronic components, the motor comprising a motor shaft;
a first blade assembly coupled to the motor shaft;
a second blade assembly coupled to the housing;
at least one support arm extending from the housing; and
a display panel coupled to the distal end of each support arm,
wherein the motor is configured to: (1) spin the first blade assembly in a first direction about a longitudinal axis of the housing, and (2) spin the second blade assembly, the at least one support arm, and the display panels in an opposite direction about the longitudinal axis of the housing, and
wherein the display panel comprises a plurality of light emitting diodes linearly arranged along a vertical axis substantially parallel to the motor's shaft's longitudinal axis;
wherein said displaying comprises activating and deactivating the light emitting diodes in predetermined sequences and for predetermined durations to cause a message to be displayed on the display panel while it is spinning.

16. The method of configuring a spinning display of claim 15, wherein said displaying comprises activating and deactivating the light emitting diodes based at least in part upon an angular rotational speed of the display panels.

17. The method of configuring a spinning display of claim 15, wherein said displaying comprises activating and deactivating the light emitting diodes independent of an angular rotational speed of the display panels.

18. The method of configuring a spinning display of claim 15, further comprising receiving a wireless command to change a value of a character in the message.

19. (canceled)

20. The method of configuring a spinning display of claim 15, wherein said predetermined durations are less than a time it takes one display panel to complete one rotation about the shaft longitudinal axis.

21. The method of configuring a spinning display of claim 20, wherein said predetermined durations are less than 25%, 5%, or 1% of the time it takes one display panel to complete one rotation about the shaft longitudinal axis.

22. The spinning display system of claim 1, wherein neither the first nor the second blade assembly is attached to the display panel.

23. The method of configuring a spinning display of claim 15, wherein neither the first nor the second blade assembly is attached to the display panel.
